(19) United States
(12) Patent Application Publication
(10) Pub. No.: US 2018/0123885 A1
(43) Pub. Date: May 3, 2018

(54) BUILDING AND APPLYING OPERATIONAL EXPERIENCES FOR CM OPERATIONS

(71) Applicant: NOKIA SOLUTIONS AND NETWORKS OY, Espoo (FI)

(72) Inventors: Kaj Peter STENBERG, Sundsberg (FI); Haitao TANG, Espoo (FI)

(73) Assignee: Nokia Solutions and Networks Oy, Espoo (FI)

(21) Appl. No.: 15/559,530

(22) PCT Filed: Mar. 20, 2015
(86) PCT No.: PCT/EP2015/055977

§ 371 Date: Sep. 19, 2017

(51) Int. Cl. H04L 12/24

(52) U.S. Cl. CPC H04L 41/0823; H04L 41/0853; H04L 41/0863; H04L 41/0816; H04L 41/069

(57) ABSTRACT

The present invention provides apparatuses, methods, computer programs, computer program products and computer-readable media regarding building and applying operational experiences for CM operations. The present invention comprises collecting operational experience information on executed operations from various logical entities via an interface, the collected operational experience information including execution data, and performance data concerning the executed operation, analyzing the operational experience information of the executed operations, storing the operational experience information of the executed operations in the central entity, and arranging the operational experience information of executed operations into different groups in the central entity according to similarities in the analyzed execution data of the operational experience information.

### FIELD OF THE INVENTION

The present invention relates to apparatuses, methods, systems, computer programs, computer program products and computer-readable media regarding building and applying operational experiences for configuration management (CM) operations.

### BACKGROUND OF THE INVENTION

There is intention to gradually evolve towards cognitive network management systems, where network future status can be predicted based on past experience and corresponding decisions made to improve either network performance or subscriber perceived experience. The target is to prevent a (network) function from executing an operation that may cause (and are known to have caused already earlier) degradation in network performance (Key Performance Indicators, KPIs) and/or unfavorable user experience, with high probability within certain network circumstances. It is also a target to make an operation of a (network) function favorable if its execution is expected to induce clear improvement in network performance/customer experience or satisfaction.

The aforementioned cognitive management requires the following information to be made available. If a function changes some parameter of a network element, the change could be notified instantly to an OSS (Operations Support System) function. In a similar way, the outcome (possible degradation or improvement achieved in network performance) caused by such a parameter value change can be recorded and stored in OSS for further diagnosis and cognitive decision making purposes. The outcome is measured by means of, e.g., certain Key Performance Indicator(s). Furthermore, the corresponding network circumstances of such an operation must also be made available for the further diagnosis and cognitive decision making purposes.

Here, parameter changes can be activated either locally (as distributed Self Organizing Networks (d-SON) or alike) or in a wider scope (as centralized SON (c-SON) or alike) for many network elements within the same plan at the same time, i.e., in the same execution round. In both cases it would be possible to measure the caused impact on network performance both qualitatively (better or worse) and quantitatively (how much better or worse).

However, (SON) function instances do not care about or are not aware of the impacts that their CM changes deliver to the network performance or customer experience, which is wider than their pre-told observation scope. Moreover, even if such impacts could be observed by a certain function, these impacts are not made available to OSS in the form of operational experience. Therefore, an OSS function (e.g., SON Coordinator) cannot filter out such SON function instances or their operations that are expected to deliver unfavorable results or performance degradations with high probability under certain network circumstances.

### SUMMARY OF THE INVENTION

It is therefore an object of the present invention to overcome the above mentioned problems and to provide apparatuses, methods, systems, computer programs, computer program products and computer-readable media regarding building and applying operational experiences for CM operations.

According to an aspect of the present invention there is provided a method for use in a logically central entity, comprising:
collecting operational experience information on executed operations from various logical entities via an interface,
the collected operational experience information including execution data, and performance data concerning the executed operation,
analyzing the operational experience information of the executed operations,
storing the operational experience information of the executed operations in the central entity, and
arranging the operational experience information of executed operations into different groups in the central entity according to similarities in the analyzed execution data of the operational experience information.

According to another aspect of the present invention there is provided a method for use in a management entity, comprising:
retrieving operational experience information of at least one previously executed operation via an interface from a central entity, and
processing a planned operation under consideration of the retrieved operational experience information.

According to another aspect of the present invention there is provided a method for use in a logically central entity, comprising:
collecting operational experience information on executed operations from various logical entities via an interface,
the collected operational experience information including execution data and performance data concerning the executed operation, and
storing the collected operational experience information of the executed operations, and
arranging the operational experience information of executed operations into different groups in the central entity according to similarities in the execution data of the operational experience information.

According to another aspect of the present invention there is provided a method for use in an analysis entity, comprising:
retrieving, from a central entity, operational experience information on executed operations,
the information including execution data and performance data concerning the executed operation,
analyzing the execution data of the operational experience information of the executed operations,
assigning an identifier to the operational experience information of executed operations according to similarities in the analyzed execution data of the operational experience information.

According to another aspect of the present invention there is provided an apparatus for use in a logically central entity, comprising:
collecting operational experience information on executed operations from various logical entities via an interface,
the collected operational experience information including execution data, and performance data concerning the executed operation,
analyzing the operational experience information of the executed operations,
storing the operational experience information of the executed operations in the central entity, and
arranging the operational experience information of executed operations into different groups in the central entity according to similarities in the analyzed execution data of the operational experience information.

According to another aspect of the present invention there is provided an apparatus for use in a management entity, comprising:
at least one processor,
and
at least one memory for storing instructions to be executed by the processor, wherein
the at least one memory and the instructions are configured to, with the at least one processor, cause the apparatus at least to perform:
retrieving operational experience information of at least one previously executed operation via an interface from a central entity, and processing a planned operation under consideration of the retrieved operational experience information.

According to another aspect of the present invention there is provided an apparatus for use in a logically central entity, comprising:
at least one processor,
and
at least one memory for storing instructions to be executed by the processor, wherein
the at least one memory and the instructions are configured to, with the at least one processor, cause the apparatus at least to perform:
collecting operational experience information on executed operations from various logical entities via an interface,
the collected operational experience information including execution data and performance data concerning the executed operation, and
storing the collected operational experience information of the executed operations, and
arranging the operational experience information of executed operations into different groups in the central entity according to similarities in the execution data of the operational experience information.

According to another aspect of the present invention there is provided an apparatus for use in an analysis entity, comprising:
at least one processor,
and
at least one memory for storing instructions to be executed by the processor, wherein
the at least one memory and the instructions are configured to, with the at least one processor, cause the apparatus at least to perform:
retrieving, from a central entity, operational experience information on executed operations,
the information including execution data and performance data concerning the executed operation,
analyzing the execution data of the operational experience information of the executed operations,
assigning an identifier to the operational experience information of executed operations according to similarities in the analyzed execution data of the operational experience information.

According to another aspect of the present invention there is provided an apparatus for use in a logically central entity, comprising:
means for collecting operational experience information on executed operations from various logical entities via an interface,
the collected operational experience information including execution data, and performance data concerning the executed operation,
means for analyzing the operational experience information of the executed operations,
means for storing the operational experience information of the executed operations in the central entity, and
means for arranging the operational experience information of executed operations into different groups in the central entity according to similarities in the analyzed execution data of the operational experience information

According to another aspect of the present invention there is provided an apparatus for use in a management entity, comprising:
means for retrieving operational experience information of at least one previously executed operation via an interface from a central entity, and
means for processing a planned operation under consideration of the retrieved operational experience information.

According to another aspect of the present invention there is provided an apparatus for use in a logically central entity, comprising:
means for collecting operational experience information on executed operations from various logical entities via an interface,
the collected operational experience information including execution data and performance data concerning the executed operation, and
means for storing the collected operational experience information of the executed operations, and
means for arranging the operational experience information of executed operations into different groups in the central entity according to similarities in the execution data of the operational experience information.

According to another aspect of the present invention there is provided an apparatus for use in an analysis entity, comprising:
means for retrieving, from a central entity, operational experience information on executed operations,
the information including execution data and performance data concerning the executed operation,
means for analyzing the execution data of the operational experience information of the executed operations,
means for assigning an identifier to the operational experience information of executed operations according to similarities in the analyzed execution data of the operational experience information.

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

### BRIEF DESCRIPTION OF THE DRAWINGS

These and other objects, features, details and advantages will become more fully apparent from the following detailed description of aspects/embodiments of the present invention which is to be taken in conjunction with the appended drawings, in which:

FIG. 1 is an overview showing an example of an architecture to which some example versions of the present invention are applicable;

FIG. 2 is a flowchart illustrating an overall process of building operational experience instances and cases according to some example versions of the present invention;

FIG. 3 is a flowchart illustrating an example of a method according to example versions of the present invention;

FIG. 4 is a flowchart illustrating an example of another method according to example versions of the present invention;

FIG. 5 is a flowchart illustrating an example of another method according to example versions of the present invention;

FIG. 6 is a flowchart illustrating an example of another method according to example versions of the present invention;

FIG. 7 is block diagram illustrating an example of an apparatus according to example versions of the present invention.

### DETAILED DESCRIPTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a self-organizing network is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

In order to conduct predictive decision making based on past experience, the system (OSS) should first record the outcome of each and every operation executed (no matter if started automatically either as d-SON or c-SON or run manually by the operator). The outcome consists of the resulting performance KPI, customer perceived experience, service quality, etc., which can be taken from the SON Verification function, PM (Performance Management) functions, and OEM (Customer Experience Management) functions for example. Also important is that the system should be able to collect and store the so-called network context data such as network conditions and other relevant circumstances (e.g. cell configuration, location, traffic profile, etc.) that may have impacted on the outcome of the operation clearly. Even more important is that the system should be able to link/associate the outcome of every such operation execution and its corresponding network context data. As of today, these data (if any) are quite scattered in the system. Some data elements are stored in different places and some part of the necessary data elements are not yet stored at all, especially for the resulting impacts on network performance (e.g., it is not yet defined how to store results from SON Verification). In addition, there is no linkage info for the specifically related data elements.

To achieve what has been described above, the following three questions need to be answered:
(1) What data elements are needed to be collected, recorded, and linked as the past experiences of the executed (SON) functions?
(2) How to make the past experiences (i.e., all the necessary data) available for the cognitive decision making (i.e., predictive decision making based on past experience)?
(3) How the cognitive network management should utilize the data in predictive decision making?

It is noted that question (3) is somewhat implementation specific and hence, different implementations (answers) to it are feasible.

According to some example versions of the present invention, there is proposed a solution to build and apply operational experiences so that corresponding (SON) functions can be operated in the context of cognitive network management.

The solution according to some example versions of the present invention first defines the data elements needed for an operational experience instance concerning an operation of a (SON) function. It then defines the methods to collect, store, and further process the defined data elements.

Further, according to some example versions of the present invention, there is also defined an approach to link these data elements into a complete operational experience instance, and to further link all those similar operational experience instances into an operational experience case so that the operational experiences can be practically used for the operation of a function.

Based on these definitions, some example versions of the present invention further provide the method to make the past experiences (i.e., all the necessary data) available for the cognitive decision making (i.e., decision making based on past experience). In addition, some example versions of the present invention define a set of interfaces that serve as a critical part of the aforementioned methods and solutions.

Architecture for Collecting the Event History data

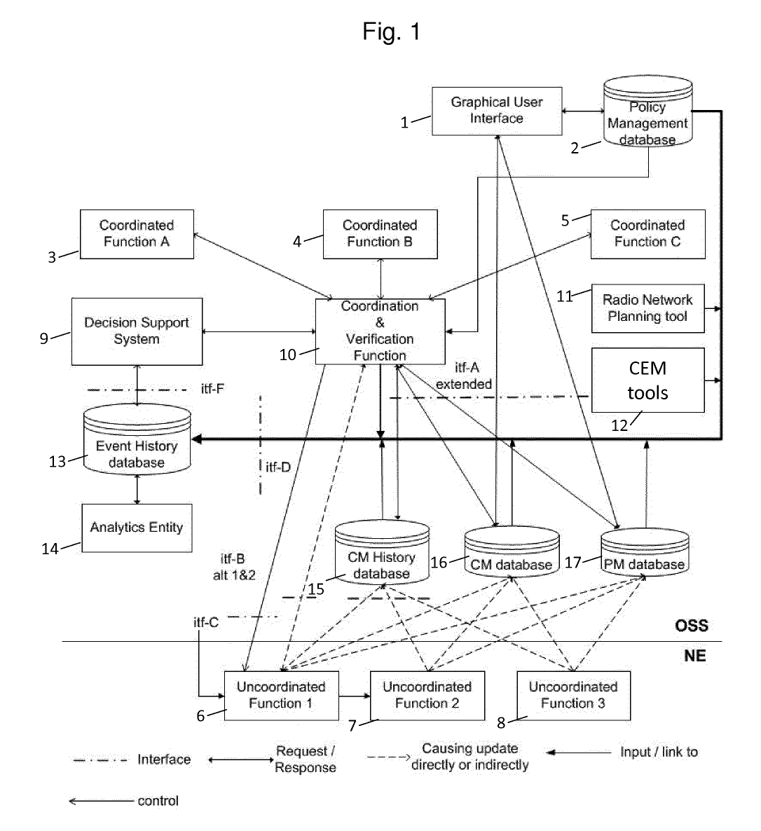

FIG. 1 shows an example of an architecture to which some example versions of the present invention are applicable.

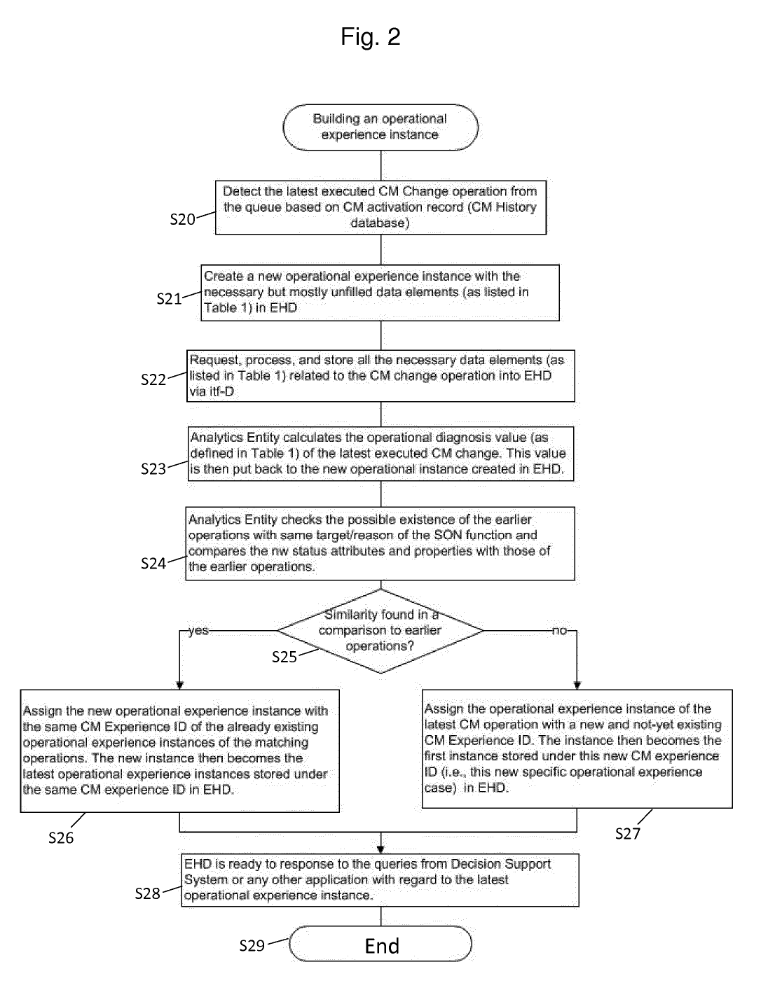

Later in the description, a high-level flowchart (FIG. 2) is given and the solution benefits are explained, which helps to understand how the whole solution works. In addition, non-limiting example use cases are given on how the cognitive network management should utilize the experience data in predictive decision making.

FIG. 1 illustrates an architecture for collecting the event history data, i.e. experience and/or verification results of the SON operations. In the following the elements constituting the architecture shown in FIG. 1 will be described.

The Graphical User Interface (GUI) 1 is used for monitoring the statuses of different (SON) operations, but also used for the insertion of different customer policy based operational steering parameters for algorithms and for other preferences (e.g. KPI thresholds to be followed, targets for optimization aka characteristics: coverage, capacity, quality, mobility, traffic throughput, etc.).

The Policy Management database 2 is a storage for different operator policy based settings for different (SON) operations in different scenarios. Settings and preferences are stored as profiles and there can be various of them stored for different purposes and scenarios depending on the type of (SON) operation and its purpose or target, cluster type, cell type, service type, etc. For each profile a unique Profile ID must be created and linked or associated to the corresponding SON function by means of SFI_ID.

A Function 3 to 8, including coordinated functions and uncoordinated functions, denotes generally an entity that realizes certain functionality for a network/its OSS, which can be started/executed in many different ways: triggered based on event/KPI or alarm), started by operator for one time execution immediately or scheduled with certain intervals for a certain period of time, etc.

The Coordinated Function 3 to 5 can be considered as any function where its intended operation needs the decision by another function (e.g., SON coordination function) before its intended operation can be executed or revoked, etc.

The Uncoordinated Function 6 to 8 can be considered as any function that can directly induce certain changes in CM data itself without the decision of another function (e.g., SON coordination function).

A Decision Support System (DSS) 9 analyses data that is stored in an Event History database (EHD) 13, recognizes series or patterns in consecutive CM changes and their impacts on the operational experience, and draws logical conclusions based on the analysis and recognition in order to make predictive decision about the future actions for Cognitive Network Management.

A Coordination and Verification Function 10 contains two main components: Conflict detection and resolution (aka collision avoidance) as a pre-action and SON Verification for the assessment of the impact of CM changes as a post-action including automatic rollback function, in case significant performance degradation is detected.

A Radio Network Planning tool 11 contains the data (e.g. site location and antenna data) that is not available through any other database.

The CEM tools 12 are different tools that produce data (e.g. Customer Experience Insights, Traffic Distribution and location based Geo KPIs) that can be used for the evaluation of the end user perceived experience (customer or service centric experience). Thus, they will complement the conventional PM data (reflecting mainly the network centric experience) that is used for the assessment of the CM changes in SON Verification.

The Event History database (EHD) 13 is a storage, which contains all the relevant information from the (SON) operations executed in the past. In this database different data elements are linked together such as network elements' identification to the other network conditions, configuration and circumstances together with the operational experience caused/achieved by executing a certain SON function. Operational experience is depending on the type of a (SON) function and can be understood as a result of the execution of the function (i.e. CM changes causing impact either to customer, service or network centric experience). As there is a correlation between these three different types of perceived experiences, operational experience can be considered to be a combination of those.

An Analytics Entity 14 calculates the difference between operational experience data caused by the CM change in a comparison to the situation prior to the change and stores this information (called operational experience instance) back to EHD with a linkage to the necessary data elements as described Table 1 (which is described later). It also determines the grouping of cells into different clusters according to variable attributes as listed in Table 1. The Analytics Entity 14 can be considered as an integral part of the Event History database.

A CM History database 15 is storage of the CM changes in the past. Network elements report CM changes (caused by automated or manual operations) to this database with certain information elements.

A CM database 16 contains actual network configuration, parameter values, and information elements describing the current status.

Further, a PM database 17 contains KPIs with certain time aggregation (e.g. 15 min, hourly, daily, weekly).

In FIG. 1, a dashed-dotted line indicates an interface, a double-headed solid arrow indicates a request/response, a dashed arrow indicates that direct or indirect update is caused, a solid arrow indicates control, and a bold solid arrow indicates input or link to the respective entity.

### DESCRIPTION AND DEFINITION OF INTERFACES

In the following, the different interfaces illustrated in FIG. 1 will be explained.

Interface-A (Extended)

Interface-A (itf-A) was introduced for querying the CM history database/file and CM database for the CM activation record and status of relevant managed object DN, etc. Now, according to some example versions of the present invention, it has been extended with “write” and “request” to the PM data in order to be able to collect the operational experience caused by these functions. The extended interface-A is needed between the SON verification function/Event History database/human operator and the CM & PM databases, as shown in FIG. 1.

This interface is defined for an OSS function (e.g., EHD function)
to request CM History database/file for the CM activation record(s) and, if any, the relevant CM plan(s) as the following,
   Request (Impact Area, optionally Impact Time) to CM History database/file
   Response (CM activation record(s) and optionally CM plan(s), that are related to the given Impact Area) from CM History database/file
to request CM database for the status information of a relevant CM activation/the relevant function that either made the CM activation or relates to the given Impact Area as the following,
   Request (Managed Object DN) or Request (Impact Area, optionally Impact Time) to CM Data database
   Response (Status of Managed Object DN) or Response (one or more Statuses of Managed Object DNs that are relevant to the Impact Area and optionally Impact Time) from CM Data database
to start and finish the calculation of CM assessment scores in SON verification
   Individual cell level KPIs to be collected for a certain period of time for the calculation of the CM assessment score of the latest executed CM operation
      Impact Area—the list of network elements (MO DNs) determines which cells will deliver cell level and/or cell pair level KPIs for SON verification function
      Starting time from—<CM activation time stamp>
      Ending time from—Impact Time: Visibility Delay: end at <UTC>and further, according to some example versions of the present invention, the interface is defined
to store SON verification results to PM database
   Write (CM assessment score, SFI_ID, Entry_id) to PM database
to request PM database for the relevant KPIs and SON Verification results that relates to the network elements of the given Impact Area
   Request (Managed Object DN) or Request (Impact Area), Request (Time stamp of CM activation), or Request (Impact Time: Visibility Delay end at <UTC>) to PM database
   Response (Feature impact KPI(s) of the Managed Object DN relative to the Time stamp of CM activation) or Response (SON Verification results of one or more Managed Objects DNs that are relevant to the Impact Area and Impact Time)

Interface-B, Alternative 1 & 2

Interface-B (itf-B) was introduced to request relevant uncoordinated functions for the missing history information of a CM activation either indirectly (alterative 1) or directly (alternative 2). As such it is not relevant within the present invention for the collection of operational experience. However, the information stored in CM History database via itf-B is very important for linking the reason and target of a specific SON (or alike) function into the EHD with the rest of the relevant data elements.

Interface-C

Interface-C (itf-C) was introduced to provide control for an uncoordinated function. Not directly relevant for the present invention, however visible in the architecture description, see FIG. 1.

Interface-D

According to some example version of the present invention, a new interface-D (itf-D) is defined which is the main interface to collect all the necessary information and data elements to be stored into the Event History database (EHD). As such, it can be considered as the main data interface that connects different architecture components to the EHD. It should be also extendable to support more data sources (Big Data), which may provide important new data elements relevant for the evaluation of the operational experience in the future.

This interface is defined to collect and store all the relevant data elements (as listed in Table) of the operational result caused by the execution of a (SON) function (or CM change operation).

Interface D supports EHD to request all the relevant databases and tools as shown in FIG. 1. Itf-A serves itf-D to support the requests of the EHD to the CM History and PM databases as shown in FIG. 1. As an alternative, itf-B can serve itf-D to support the EHD requests to uncoordinated functions. The main purpose of itf-A and itf-B in this context is to guarantee that all of the necessary data of executed CM functions is stored in CM History and PM databases and thus made available for the EHD.

In summary, itf-D supports EHD to request for the following data concerning the executed function instance (e.g., c-SON) or uncoordinated CM change operation (e.g., d-SON):
the CM activation record(s) from CM History database/file and, if any, the relevant CM plan(s) as the following,
   Request (SFI_ID, entry_id, Impact Area, optionally Impact Time) to CM History database/file
   Response (CM activation record(s) from CM History database and CM plan(s), that are related to the given Impact Area) from CM database
the reason or target of the SON function either from Policy Management or CM History database
   Request (SFI_ID, entry_id) to CM History database or Policy Management database
   Response (reason and target of the SON function, optionally also the network (nw) characteristic) from CM History database or Policy Management database
the KPI thresholds that are meaningful for triggering the SON function of interest from the corresponding profile that has been stored in Policy Management database
   Request (SFI_ID) from Profile stored in PMD
   Response (KPI threshold settings inserted by operator)
the operation execution state of the given SON function from SON Coordinator
   Request (SFI_ID, entry_id, MO DN) to SON Coordinator
   Response (operation execution state) from SON Coordinator (SON Function operational state register)
the operational result caused by the execution of the given SON function or CM change operation
   Request (MO DN, timestamp for collecting operational experience) to PM database or
   Request (SFI_ID, entry_id, and optionally timestamp for collecting operational experience) to SON Coordinator
   Response (CM assessment score and/or individual/group of feature impact KPIs) from PM database or (Rollback activation record) from SON Coordinator
   Request (SFI_ID, entry_id, MO DN, timestamp for collecting operational experience) to CEM tools
   Response (customer and service centric triggers and KPIs, Geo-KPIs and events and other subscriber experience centric KPIs from the cells as requested by MO DN) from CEM tools
the network status attributes and properties of the corresponding SON Function instance or CM change operation
   Request (SFI_ID, entry_id) to SON Coordinator to fetch the related MO DNs from the SOI's metadata
   Response (impact area of the CM operation, i.e. list of related MO DNs) from SON Coordinator
   Request (MO DN) to RNP-tool to collect more insights into cell characteristics
   Response (cell cluster type, site/antenna location, antenna attributes)
   Request (MO DN) to CM database to collect more information of the cell type&size, other configuration patterns and relevant parameter values of the cells
   Response (cell type&size, antenna attributes, other relevant configurations and parameter values) from CM database
   Request (MO DN, time period as <start time-end time>) to CEM tools to export the traffic pattern of the cells
   Response (traffic pattern and related attributes of the listed cells)
   Request (MO DN, time period as <start time-end time>) to CM History database for extracting additional information for cell clustering according to operational pattern
   Response (attributes related to operational pattern see Table 1) for the requested cells

The outcome (i.e. the operational result) caused by the known (SON) function with all of the other relevant attributes are then linked together and stored in the same record in EHD.

Interface-F

According to some example version of the present invention, a new interface-F (itf-F) is defined for the DSS to request specific experience info from EHD for, e.g., further analysis, pattern recognition, and predictive decision making. The specific experience (if any) would relate to some historical operational experience(s) of the CM operation(s) executed in the past within certain cell clusters (i.e. group of cells with similar nw status and attributes),
Requests from DSS to EHD
   Request (SFI_ID of planned/intended CM operation and its Impact area with nw status attributes and the planned size of the change in parameter value(s) or in any other CM settings) to Event History database
   Request (Target of CM change and Impact Area with nw status attributes and current CM data) to EHD
Responses from EHD to DSS
   Response (expected operational experience with certain probability if the planned CM operation would be executed in similar nw status conditions) from EHD, or
   Response (proposal for next CM operation that will help to achieve the requested CM intention/target with certain probability incl. proposal for the size of the coming change in CM settings or parameter values) from EHD

Definition of Data Elements of an Operational Experience Instance

The following Table 1 defines the data elements needed for an operational experience instance induced by the CM change of a function (SON or alike). That is, a specific CM operation creates a specific operational experience instance. A specific operational experience instance can be identified uniquely in the same way as its originating CM change function—by its specific SFI_ID and Entry_id. In Table 1, some of the data elements are not new individually themselves, since they have been defined before. However, constructing the data elements into an operational experience instance is new. Further, some those data elements are newly defined in the table, which is specifically indicated in the table. This table also shows the different data sources from where the data elements can be collected for the operational experience instance. These data elements need to be collected and stored/linked into the Event History database via interface-D.

TABLE 1
List of data elements needed to compose an operational experience
instance for corresponding function and network element

| Name of the data element | Type | Source | Example/explanation |
|---|---|---|---|
| Record_id | num | Analytics Entity | Unique identification of the |
| | | | operational experience instances |
| | | | stored in EHD-can be used to |
| | | | refer a specific operational |
| | | | experience instance in a |
| | | | chronological order. |
| CM activation record: | | CM History | f) CM Intention origin (new) |
| a) MO DN | string | database | Answers the question, who |
| b) SFI_ID | string | | initiated the CM change intention: |
| c) Entry_id | num | | human (manually) or system |
| d) Timestamp | date | | (automatically), This information |
| e) Parameter name | string | | needs to be linked to CM History. |
| Old & new | num | | |
| value | | | |
| f) CM intention origin | string | | |
| (new) | | | |
| Reason or target of the | string | | g) Information about the event |
| (SON) function (new): | | | (i.e. what action) and why the |
| g) Event based | | g) CM History | (SON) function was triggered |
| triggering | | h) Policy | must be stored in CM History. |
| h) Operator defined | | management | Insertion of the information |
| and constructed | | db | should also be supported by the |
| (SON) function | | i) CM History | GUI when creating the event by a |
| i) One time ad-hoc | | j) CM History | human operator. |
| attempt to | | | h) For each operator defined |
| optimize/improve nw | | | (SON) function, a profile |
| performance with a | | | containing customer policy based |
| selected (SON) | | | settings and other relevant |
| function | | | information such as CM change |
| j) One time ad-hoc | | | intention or reason, will be |
| action to change | | | created and stored into the Policy |
| certain parameter | | | Management database. In |
| value | | | addition, customer policy based |
| | | | settings can include operators' |
| | | | preference to improve certain |
| | | | network characteristic (coverage, |
| | | | capacity, quality, mobility, traffic |
| | | | throughput, etc.) via a higher |
| | | | priority. CM change intention, |
| | | | target of the (SON) function and |
| | | | priority together with the network |
| | | | characteristic can be then linked |
| | | | to CM History. Insertion of the |
| | | | information should also be |
| | | | supported by the GUI when a |
| | | | human operator creates/sets the |
| | | | (SON) function. |
| | | | i) same as h) but without the |
| | | | need to store the info into profile |
| | | | Example: Operator needs to give |
| | | | the purpose of a (SON) function. |
| | | | For example, MRO is needed for |
| | | | the optimization of too many HO |
| | | | drops or, # of HO attempts is too |
| | | | high. |
| | | | j) same as i) - also in this case |
| | | | GUI is needed for the indication |
| | | | of the reason for this action- |
| | | | reason is directly written to the |
| | | | CM History when CM change is |
| | | | executed. However, this might be |
| | | | difficult, especially if actions are |
| | | | done locally from the element |
| | | | manager or maintenance terminal |
| KPI Thresholds of the | num | Policy | KPI thresholds for the nw |
| constructed (SON) | | Management db | performance that the system |
| function | | | should follow and make actions |
| | | | when breached, are stored in the |
| | | | profile in PMD. |
| Operation execution state | String | SON Coordinator | Possible states: |
| of the (SON) function | | | rejected, approved, rescheduled, |
| | | | blacklisted (for the coordinated |
| | | | function) as well as |
| | | | Enable/Disable, |
| | | | Activate/Deactivate, |
| | | | ImpactUpdate (for the |
| | | | uncoordinated function) |
| Operational result i.e. | value | (1) SON | Network centric evaluation |
| performance/experience | | Coordinator | (1) Rollback decision |
| data caused by the | | (2) PM database | (2) SON Verification result as |
| execution of the CM | | (3) CEM tools | CM assessment score (c- |
| operation (partly new) | | | SON only) |
| | | | Feature impact KPI(s) (for |
| | | | d-SON) as well any other |
| | | | individual cell level KPI(s) |
| | | | of importance to operator |
| | | | Subscriber centric evaluation: |
| | | | (3) CEMoD-Subscriber |
| | | | aware triggers on L3 |
| | | | messages, e.g. on: |
| | | | Location Update, Call |
| | | | Initiation, PDP Context |
| | | | Activation, etc. and other |
| | | | customer experience |
| | | | centric KPIs |
| | | | CEM tool-Geo-KPI |
| | | | based triggers and events |
| | | | CEM tool-Subscriber |
| | | | and service aware triggers |
| | | | and KPls, |
| | | | Customer Experience |
| | | | Index (CEI) |
| Input collection trigger | time | c-SON: SON | Defines the time point when the |
| point for | | Coordinator | reliable and matured |
| performance/experience | | | operational experience can be |
| data | | d-SON: CM | taken for further utilization |
| k) c-SON: Impact | | History and | k) c-SON: timestamp, when |
| Time: Visibility | | optionally SON | operational stage for visibility |
| Delay: end at | | Coordinator or | delay period is over and |
| <UTC> | | PMD | relevance interval has started- |
| l) d-SON: predefined | | | this is the point in time when |
| Impact time: | | | to take the input value from |
| Visibility Delay: end | | | SON Verification for the |
| at <UTC> (new) | | | resulting operational network |
| | | | centric experience |
| | | | complemented with other |
| | | | KPIs and optionally also the |
| | | | subscriber centric experience |
| | | | (i.e. insights from CEM tools) |
| | | | and store the results in EHD. |
| | | | l) d-SON: CM activation |
| | | | timestamp (from CM History), |
| | | | when the action was exactly |
| | | | executed + some time shift for |
| | | | maturity-time shift can be |
| | | | either hardcoded being |
| | | | always the same in every |
| | | | situation or given by the |
| | | | operator (depending on the |
| | | | SON function) via the GUI in |
| | | | SON Coordinator and stored |
| | | | in PMD. This defines the point |
| | | | in time when to take input for |
| | | | feature impact KPI analysis |
| | | | and optionally also for the |
| | | | CEM related data to store the |
| | | | results in EHD. |
| Reference or baseline | value | (4) PM database | For c-SON operations, the |
| performance/experience | | (5) CEM tools | CM assessment scores show |
| data | | | directly the performance |
| | | | evolution after the CM |
| | | | change. For deeper insight, |
| | | | additional KPIs of importance |
| | | | can be fetched. |
| | | | (4) Feature impact KPI(s) as |
| | | | individual cell level KPI(s) |
| | | | and CM assessment |
| | | | scores |
| | | | (5) Subscriber and service |
| | | | centric KPI data from |
| | | | CEM tools as described |
| | | | above |
| Trigger point in time for | time | CM History and | System collects reference data/ |
| input collection of | | optionally Policy | feature impact KPIs from the |
| experience reference | | Management | last granularity period prior to |
| data (d-SON) (new) | | database | the CM change. Exact time for |
| | | | the activation of CM change can |
| | | | be detected from the CM |
| | | | history. Duration of the |
| | | | granularity period is depending |
| | | | on the CM change operation |
| | | | and the type of experience data |
| | | | (e.g. with CEM tool's minimum |
| | | | period is one minute as with |
| | | | conventional PM data it is 15 |
| | | | min.) |
| Operational diagnosis | value | Analytics Entity | This is the difference (i.e. |
| (new) | | | degradation, neutral, |
| | | | improvement) measured certain |
| | | | time after the CM change has |
| | | | been executed and compared to |
| | | | the preceding situation (i.e. |
| | | | reference or baseline data). |
| | | | This information is calculated in |
| | | | Analytics Engine and attached |
| | | | back to the corresponding other |
| | | | info elements (as listed in this |
| | | | table) in EHD. |
| Network status attributes | | | Network status attributes and |
| and properties | | | properties are used for grouping |
| m) Impact area of the | String | m) SON | cells into different clusters |
| CM operation | | Coordinator | according to their similarities in |
| n) Cell cluster type | | or CM | conditions, circumstances and |
| (dense urban, | | database | other characteristics |
| urban, suburban, | | | |
| residential, rural, | | n) Radio | m) Impact area can be |
| indoor etc.) | | Network | retrieved from the function |
| o) Cell and antenna | | Planning | metadata via SON |
| location | | tool | Coordinator or, retrieved |
| p) Antenna attributes | | o) RNP-tool | from CM database for d- |
| (height, type, | | p) RNP-tool | SON functions especially. |
| bearing, beam | | | |
| width, etc.) | | q) CM | |
| q) Cell type (macro, | | database | |
| micro, pico, femto, | | | |
| indoor, etc.) | | r) CEM tools | r) Geo-mobility describes the |
| r) Traffic pattern (load | | | physical speed of the UE |
| level, # of active | | | (e.g. static, walking, driving, |
| UEs, type of | | s) CM History | high speed train, etc.) |
| applications used, | | database | |
| QoS, geo-mobility | | | |
| nature of the | | | |
| devices, etc.) | | | |
| s) Operational pattern | | | |
| (# of cell outages | | | |
| due to ES or any | | | |
| failure, changes in | | t) CM | |
| capacity or traffic | | database | |
| throughput due to | | | |
| dynamic spectrum | | | |
| allocation or carrier | | | |
| aggregation, special | | | |
| social event, etc.) | | | |
| t) Configuration | | | |
| pattern (the actual | | | |
| configuration and | | | |
| relevant parameter | | | |
| values of the cells) | | | |
| CM Experience ID | String | Analytics Entity | CM Experience ID is needed to |
| (new) | | | link/refer as many similar/same |
| | | | operational experience instances |
| | | | as possible. |
| | | | The purpose of the ID is to |
| | | | identify the specific operational |
| | | | experience case (identified by |
| | | | CM Experience ID) where this |
| | | | operational experience instance |
| | | | belongs. A specific experience |
| | | | case can consist of one or more |
| | | | operational experience instances. |

Method to Collect and Store the Operational Experience Data for a CM Operation

According to some example version of the present invention, there is proposed a method for collecting and storing the operational experience data for a CM operation.

It is proposed to collect and store the resulting network centric experience data (CM assessment scores or feature impact KPIs) complemented with subscriber centric experience data from OEM tools. All of the data must then be linked to the corresponding network elements and to the originating (SON) function or CM change operation together with the target/reason for the function/CM change itself. All of the necessary data elements and information shall be stored into/made available at the same place (i.e. Event History database) for further processing and analysis.

Within the context of coordinated operation (e.g., centralized SON), the impact of the CM change can be verified by a special function called (SON) verification. This is done by giving CM assessment scores in cycles in order to follow-up the performance evolution after the CM change has been executed, with the CM assessment score attached as a part of the operational experience data directly to the corresponding function.

The solution according to some example versions of the present invention proposes to store the CM assessment score (from SON verification function) in the PM database tables together with the other KPIs so that the synchronization of the CM assessment cycle is correlating with the corresponding PM granularity. As described above, Interface-A can be extended to serve as the interface between the verification function and the PM database (see FIG. 1). The extension needs to be defined in order to be able to start and finish the collection of selected individual cell level KPIs for the calculation of the CM assessment score in SON coordinator/SON verification function. The CM assessment score will then be sent back to PM database and stored there within the same granularity as the KPIs used for the calculation.

The CM Assessment scoring only reflects the evolution of the network centric experience. Optionally, it can be complemented by any other individual cell level KPI that has importance to operator and optionally also by CEM data in order to indicate better the subscriber centric experience as well.

Within the context of uncoordinated operation (e.g., distributed SON or other), the method to collect the resulting outcome or experience data is very much similar to the c-SON case. Actually the only difference is the availability of the CM Assessment scoring, as this is not computed by SON verification function for d-SON operations. Rather, the outcome can be verified based on predefined list of “feature impact KPIs” stored in PM database respectively.

Method to Calculate the Operational Diagnosis for a CM Operation

Further, according to some example versions of the present invention, there is proposed a method for calculating the operational diagnosis for a CM operation.

According to this method, the Analytics Entity calculates the operational diagnosis (OD) for a specific CM operation. It requires both the resulting performance and/or experience data caused by the latest CM change as well as the earlier corresponding reference data as an input from EHD to Analytics Entity. The operational experience instance is then calculated by comparing the latest resulting performance to the baseline (i.e. to the situation/performance data before executing the CM change). In this way the evolution of the network performance or customer perceived experience can be demonstrated.

In this case the OD is calculated as a delta between the performance/experience data of the last operation in a comparison to the data prior to that CM change, when the other attributes are considered unchanged or approximately the same. The resulting OD is then attached back to the originating CM operation together with the rest of the attributes (as shown in Table 1). The newly created record is then labeled with a unique identification (i.e. record_id), which can be allocated by the system based on the activation timestamp in CM History (entry_id as such does not necessarily reflect to the order of operations taking place in time). In this way, the records can be organized in a chronological order and, the evolution of the performance/experience in certain area can be analyzed over certain period of time.

Method to Assign a Specific CM Experience ID to the Operational Experience Instance of a Specific CM Operation

Furthermore, some example versions of the present invention propose a method for assigning a specific CM Experience ID to the operational experience instance of a specific CM operation.

This method is needed for the operation experience instances of both coordinated function and uncoordinated function. Collecting, processing, and storing of the data as described above is only the first step in making an operational experience instance available. In the next step, Analytics Entity has to determine and assign a CM Experience ID for the operational experience instance based on the attributes as listed in Table 1.

The computation of CM Experience ID requires the nw status attributes and properties (as listed in Table 1) as input from EHD to Analytics Entity. As soon as there is a new CM operation event (identified by unique SFI_ID and entry_id) stored in the EHD, Analytics Entity checks the possible existence of the earlier operations with same target/reason of the SON function and compares the nw status attributes and properties with those of the earlier operations.

In case similarity with some of the earlier operations is found, the given new CM operation becomes the latest one in that sequence of similar CM operations stored already in the event history, where their operational experience instances are all linked by an already existing CM Experience ID as one individual operational experience case together. The operational experience instance of the new CM operation is thus assigned with this existing CM Experience ID.

Similarity is a metrics that tells how close/different two given operational experience instances are from each other, where the similarity is assessed based on a relevant similarity measure.

In case no matching to earlier ones can be found, the operational experience instance of the new CM operation is then assigned with a new and not-yet-existing CM Experience ID. That is, this operational experience instance is then the first operational experience instance of a new operational experience case.

Method to Utilize the Operational Experience for Cognitive Decision Making

In the following, a method to utilize the operational experience for cognitive decision making according to some example versions of the present invention is described.

The cognitive network management and predictive decision take place in the Decision Support System (DSS). They utilize the experience info stored in EHD. DSS can be understood as a machine learning engine that takes input from EHD for its algorithms used, e.g., for pattern recognition, data search and different query purposes. In order to make the data stored in EHD available for further queries and analysis in DSS, a new interface (itf-F) is needed between DSS and EHD.

FIG. 2 is a diagram illustrating a summary of the above described methods and depicts the process and data flow to make an individual operational experience instance and then group it into a specific operational experience case according to some example versions of the present invention.

In step S20, the latest executed CM change operations are detected from the queue based on CM activation record (CM History database).

Then, in step S21, a new operational experience instance with the necessary but mostly unfilled data elements (as listed in Table 1) is created in the EHD.

Further, all the necessary data elements (as listed in Table 1) related to the CM change operation are requested, processed and stored into EHD via itf-D in step S22.

Then, the Analytic Entity calculates in a step S23 the operational diagnosis value (as defined in Table 1) of the latest executed CM change. This value is then put back to the new operational instance created in EHD.

Further, in step S24, the Analytic Entity checks the possible existence of the earlier operations with same target/reason of the SON function and compares the nw status attributes and properties with those of the earlier operations.

If it is determined a step S25, that a similarity is found in a comparison to earlier operations (Yes in step S25), the procedure proceeds to step S26. Otherwise (No in step S25), the procedure proceeds to step S27.

In step S26, the new operational experience instance is assigned with the same CM Experience ID of the already existing operational experience instances of the matching operations. The new instance then becomes the latest operational experience instance stored under the same CM experience ID in EHD.

In step S27, the operational experience instance of the latest CM operation is assigned with a new and not-yet existing CM Experience ID. The instance then becomes the first instance stored under this new CM Experience ID (i.e. this new specific operational experience case) in EHD.

Then, in a step S28, the EHD is ready to respond to the queries from the Decision Support System or any other application with regard to the latest operational experience instance.

In a step S29, the procedure ends.

Example Benefits of the Operational Experience Instances

In the following there are described some example benefits of the operational experience instances.

As mentioned already earlier, it can be assumed that, with similar CM changes in same type of conditions and circumstances, a same kind of operational experience can be achieved with high probability. As this information is stored into the Event History database, it can be used for predictive decision making—as soon as there is statistically sufficient amount of operational experience instances stored and when the network conditions and circumstances are known with the planned next SON function to be executed in the future. The Decision Support System is able to predict the possible expected outcome with some precision already before the SON function is even executed.

The utilization of operational experience history (in form of operational experience instances stored in the EHD) in predictive decision making gives the operator significant advantages:
1) CM change operations/functions resulting in nw performance degradation or rollback in certain conditions can be avoided in advance in similar conditions
2) CM change operations/functions resulting in nw performance improvements in certain conditions can be made favorable in cases with similar conditions
3) CM change operations/functions, that have succeeded to satisfy operator's targets for the optimization or nw performance evolution, can be made preferable (e.g. prioritized higher or started more frequently, etc.)
4) Selection of the CM change operation according to operator's target. For example, operator is interested in improving mobility (e.g. HO success rate)
   Selection of the specific CM Change operation (to be executed next) that has recorded the highest success in operational experience instance in the past e.g. with regard to improvement of HO success rate
   Selection of the specific parameter value or any other attribute value (for the CM operation to be executed next) that has resulted in the highest operational experience instance in the past e.g. with regard to improvement of HO success rate

Example use Cases of the Operational Experience Instances

In the following there are defined a few listed use cases and examples on how the DSS would utilize the operational experience data stored in the EHD.

Below are a few listed use cases on how DSS would utilize the operational experience instances stored in the EHD, while its corresponding itf-F definition is already described above.
1. Referral of the current or planned CM intention to the stored operational experience history
   a. If same or similar CM operations in the past have failed or been frequently rolled back, DSS could consider that the current or planned CM intention would most likely result the same. In that case, this kind of CM intention could be rejected straight away.
   b. Under the given network status, possibly there has been some other CM operation in the past that have caused the targeted improvements. In this case, the system (e.g., DDS) can automatically propose the historical CM operation to be executed again if the current nw status is similar to the historical one.
2. Operator can search for ideas based on the stored operational experience history, for what to do or how to improve nw status through
   a. Identifying the current nw status of the interested area or group of cells
   b. Using the current nw status as index to search the stored experience history.
   c. If same or similar case is found, the query will return the CM operation(s) that have caused the earlier (favorable) experience.
   d. If same or similar case is found, the query can also return the CM settings and parameter values of the earlier CM operation(s) that have caused the targeted/wanted earlier experience. Proposal to use the same settings with the next CM operation with similar performance or experience target can be made.
3. Prediction of a future CM operation based on the stored operational experience history through
   a. Using the past CM operations and the intended future CM operation as the index to search the stored experience history
   b. If the matching CM operation(s) are found and their nw statuses are same or similar in a comparison to the nw status causing the intended future operation, EHD reports the achievement made by the historical CM operation at the end of the match (that is matching the proposed CM operation).
   c. If multiple such matching is found, EHD reports the averaged achievement made by those historical CM operations at the end of the matches.
   d. Using the reported achievement to answer what will be the most probable achievement (e.g. improvement and how much) if the intended CM operation would be executed.

In the following, there is shown an example how the DSS could use the operational experience history stored in EHD to make its cognitive decisions:

EHD contains all the historical operational experience instances sorted by their CM Experience IDs. As soon as certain number of records (within same CM Experience ID) has been exceeded, statistical validity has been reached. This means, that a certain probability can be calculated based on the past operational experiences to reflect the chances of achieving improvement/degradation with the next planned CM change operation of similar type.

As an example, let's say that there have been 100 operational experience instances recorded under CM Experience ID “12” in Event History database, 80 of the operations have resulted in positive operational experience, respectively, 15 of them in negative and 5 have resulted in rollback. Based on the statistics, it can be presumed that with 80% probability the next (future) CM change operation that matches with CM Experience ID “12” would result in positive operational experience. With such a high probability, it would be a favorable operation for the operator or system to execute.

Not only being able to respond to the qualitative aspect of the changes (better or worse), can the system be implemented to support also the decision making from the quantitative perspective (how much better or worse?). For that sake, the system should be able to keep count on positive, neutral and negative (incl. rollback) operational experience instances within the same operational experience case (i.e. identified by its CM Experience ID). It would be also possible to compute the quantity of the expected operational experience in advance based on the past records. For example, if CM operation (e.g. antenna tilt optimization with 2 degree down tilt) has caused on the average an improvement of 5% better HO success rate when averaged over all the relevant operational experience instances stored in EHD under the same CM Experience ID, then that would be the expected operational experience when a next similar CM operation will be executed.

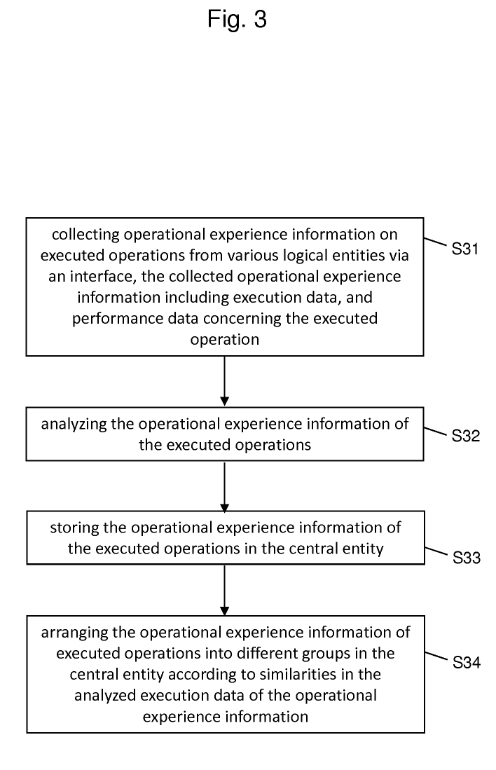

In the following, a more general description of example versions of the present invention is made with respect to FIGS. 3 to 7.

FIG. 3 is a flowchart illustrating an example of a method according to example versions of the present invention.

According to example versions of the present invention, the method may be implemented in or may be part of logically central entity, like an EHD including an analytics entity or the like. The method comprises collecting operational experience information on executed operations from various logical entities via an interface in a step S31, wherein the collected operational experience information include execution data, and performance data concerning the executed operation. The method further comprises analyzing the operational experience information of the executed operations in step S32, storing the operational experience information of the executed operations in the central entity in step S33, and arranging the operational experience information of executed operations into different groups in the central entity according to similarities in the analyzed execution data of the operational experience information in step S34.

According to example versions of the present invention, the operational experience information has been pre-processed by the various logical entities and exchanged between them via other relevant interfaces to enable the pre-processing.

According to example versions of the present invention, the performance data is obtained from a performance management database, the performance data being calculated by a verification function based on parameters obtained via an interface from the performance management database, and transferred back to the performance management database.

According to example versions of the present invention, the method further comprises calculating a diagnosis value of the executed operation based on the performance data of the executed operation and performance data of previous executed operations having similarities in at least some of the execution data, and storing the calculated diagnosis value in association with the operational experience information.

According to example versions of the present invention, the method further comprises arranging the operational experience information based on an identifier assigned to each of the operational experience information, where operational experience information having similarities in the execution data have the same identifier and are arranged in the same group.

According to example versions of the present invention, the performance data of the executed operation includes at least one of an assessment score, key performance indicators, customer perceived experience, service quality.

The execution data includes all the data particles relevant for the execution of the SON operation (such as activation data, records, reason/target, status attributes, trigger points, etc. as listed in table 1).

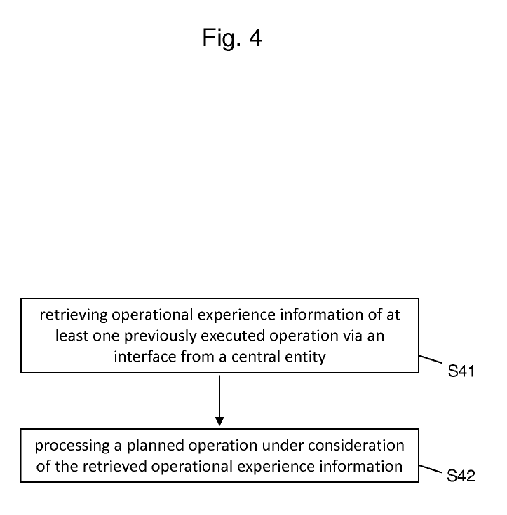

FIG. 4 is a flowchart illustrating another example of a method according to example versions of the present invention.

According to example versions of the present invention, the method may be implemented in or may be part of a management entity, like a Decision Support System or the like. The method comprises retrieving operational experience information of at least one previously executed operation via an interface from a central entity in step S41, and processing a planned operation under consideration of the retrieved operational experience information in step S42.

According to example versions of the present invention, the method further comprises analyzing execution data included in the operational experience information and determining whether the execution data of the previously executed operation have similarities with at least some of the execution data of the planned operation, if it is determined that the execution data have similarities, predicting an outcome of the planned operation based on the retrieved operational experience information.

According to example versions of the present invention, the method further comprises determining whether to execute the planned operation based on the predicted outcome of the planned operation.

According to example versions of the present invention, the method further comprises identifying execution data of an operation to be executed, searching the central entity for stored operational experience information of previous operations based on the identified execution data, analyzing the retrieved operational experience information of the previous operations, if the previous operations having similarities in at least some of the execution data resulted in positive operational experiences, retrieving parameters of the previous operations having similarities in at least some of the execution data from the operational experience information, and applying the retrieved parameters for the operation to be executed.

According to example versions of the present invention, the method further comprises, if the previous operations having similarities in at least some of the execution data resulted in negative operational experiences, rejecting the execution of the planned operation.

According to example versions of the present invention, the method further comprises arranging the operational experience information based on an identifier assigned to each of the operational experience information, where operational experience information having similarities in the execution data have the same identifier and are arranged in the same group.

According to example versions of the present invention, the performance data of the executed operation includes at least one of an assessment score, key performance indicators, customer perceived experience, service quality, and the execution data include at least one of activation data, records, reason, target, status attributes, and triggers concerning the executed operation.

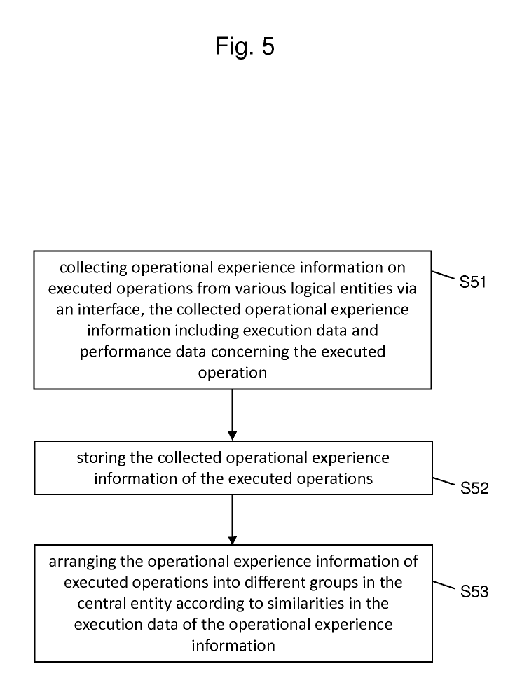

FIG. 5 is a flowchart illustrating an example of a method according to example versions of the present invention.

According to example versions of the present invention, the method may be implemented in or may be part of a logically central entity, like a EHD or the like. The method comprises collecting operational experience information on executed operations from various logical entities via an interface in step S51, the collected operational experience information including execution data and performance data concerning the executed operation, storing the collected operational experience information of the executed operations in step S52, and arranging the operational experience information of executed operations into different groups in the central entity according to similarities in the execution data of the operational experience information in step S53.

According to example versions of the present invention, the method further comprises arranging the operational experience information based on an identifier assigned to each of the operational experience information, where operational experience information having similarities in the execution data have the same identifier and are arranged in the same group.

According to example versions of the present invention, the performance data of the executed operation includes at least one of an assessment score, key performance indicators, customer perceived experience, service quality, and the execution data include at least one of activation data, records, reason, target, status attributes, and triggers concerning the executed operation.

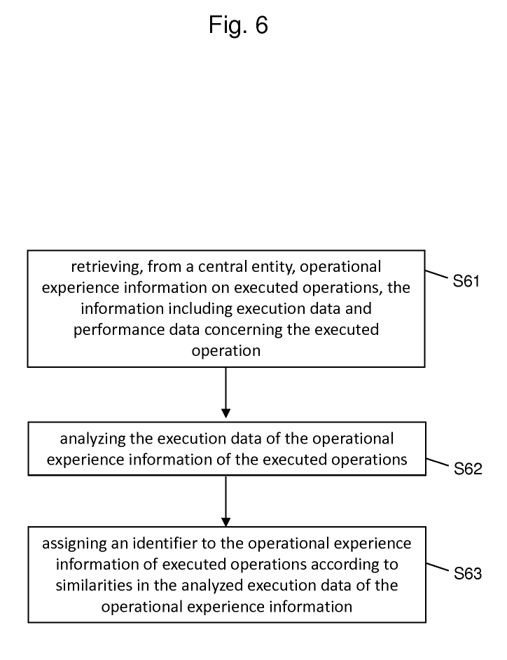

FIG. 6 is a flowchart illustrating an example of a method according to example versions of the present invention.

According to example versions of the present invention, the method may be implemented in or may be part of an analysis entity, like an Analytics Entity or the like. The method comprises retrieving, from a central entity, operational experience information on executed operations in step S61, the information including execution data and performance data concerning the executed operation, analyzing the execution data of the operational experience information of the executed operations in step S62, and assigning an identifier to the operational experience information of executed operations according to similarities in the analyzed execution data of the operational experience information in step S63.

According to example versions of the present invention, the method further comprises assigning the same identifier to operational experience information having similarities in the analyzed execution data, and assigning different identifiers to operational experience information having no similarities in the analyzed execution data, and transmitting the operational experience information to which the identifier is assigned to the central entity.

According to example versions of the present invention, the method further comprises arranging the operational experience information based on an identifier assigned to each of the operational experience information, where operational experience information having similarities in the execution data have the same identifier and are arranged in the same group.

According to example versions of the present invention, the method further comprises calculating a diagnosis value of the executed operation based on the performance data of the executed operation and performance data of previous executed operations having similarities in at least some of the execution data, and transmitting the diagnosis value associated with the operational experience information of the executed operation to the central entity.

According to example versions of the present invention, the performance data of the executed operation includes at least one of an assessment score, key performance indicators, customer perceived experience, service quality, and the execution data include at least one of activation data, records, reason, target, status attributes, and triggers concerning the executed operation.

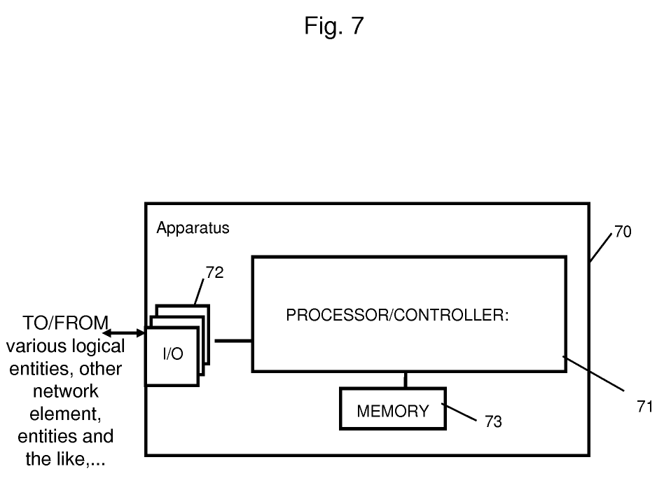

FIG. 7 is a block diagram showing an example of an apparatus according to example versions of the present invention.

In FIG. 7, a block circuit diagram illustrating a configuration of an apparatus 70 is shown, which is configured to implement the above described aspects of the invention. It is to be noted that the apparatus 70 shown in FIG. 7 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 70 may comprise a processing function or processor 71, such as a CPU or the like, which executes instructions given by programs or the like. The processor 71 may comprise one or more processing portions dedicated to specific processing as described below, or the processing may be run in a single processor. Portions for executing such specific processing may be also provided as discrete elements or within one or further processors or processing portions, such as in one physical processor like a CPU or in several physical entities, for example. Reference sign 72 denotes transceiver or input/output (I/O) units (interfaces) connected to the processor 71. The I/O units 72 may be used for communicating with one or more other network elements, entities, terminals or the like. The I/O units 72 may be a combined unit comprising communication equipment towards several network elements, or may comprise a distributed structure with a plurality of different interfaces for different network elements. Reference sign 73 denotes a memory usable, for example, for storing data and programs to be executed by the processor 71 and/or as a working storage of the processor 71.

The processor 71 is configured to execute processing related to the above described aspects. In particular, the apparatus 70 may be implemented in or may be part of a logically central entity like a EHD including an analytics entity or the like, and may be configured to perform a method as described in connection with FIG. 3. Thus, the processor 71 is configured to perform collecting operational experience information on executed operations from various logical entities via an interface, the collected operational experience information including execution data, and performance data concerning the executed operation, analyzing the operational experience information of the executed operations, storing the operational experience information of the executed operations in the central entity, and arranging the operational experience information of executed operations into different groups in the central entity according to similarities in the analyzed execution data of the operational experience information.

According to other example versions of the present invention, the apparatus 70 may be implemented in or may be part of a management entity, like a Decision Support System or the like, and may be configured to perform a method as described in connection with FIG. 4. Thus, the processor 71 is configured to perform retrieving operational experience information of at least one previously executed operation via an interface from a central entity, and processing a planned operation under consideration of the retrieved operational experience information.

According to other example versions of the present invention, the apparatus 70 may be implemented in or may be part of a logically central entity, like a EHD or the like, and may be configured to perform a method as described in connection with FIG. 5. Thus, the processor 71 is configured to perform collecting operational experience information on executed operations from various logical entities via an interface, the collected operational experience information including execution data and performance data concerning the executed operation, and storing the collected operational experience information of the executed operations, and arranging the operational experience information of executed operations into different groups in the central entity according to similarities in the execution data of the operational experience information.

According to other example versions of the present invention, the apparatus 70 may be implemented in or may be part of an analysis entity, like an Analytics Entity or the like, and may be configured to perform a method as described in connection with FIG. 6. Thus, the processor 71 is configured to perform retrieving, from a central entity, operational experience information on executed operations, the information including execution data and performance data concerning the executed operation, analyzing the execution data of the operational experience information of the executed operations, assigning an identifier to the operational experience information of executed operations according to similarities in the analyzed execution data of the operational experience information.

For further details regarding the functions of the apparatus 70, reference is made to the description of the method according to example versions of the present invention as described in connection with FIGS. 3 to 6.

Thus, it is noted that the apparatus for use in logically central entity including the analytics entity, the apparatus for use in a analysis entity, the apparatus for use in a management entity, and the apparatus for use in a logically central entity generally have the same structural components, wherein these components are configured to execute the respective functions of the entities, respectively, as set out above.

In the foregoing exemplary description of the apparatus, only the units/means that are relevant for understanding the principles of the invention have been described using functional blocks. The apparatus may comprise further units/means that are necessary for its respective operation, respectively. However, a description of these units/means is omitted in this specification. The arrangement of the functional blocks of the apparatus is not construed to limit the invention, and the functions may be performed by one block or further split into sub-blocks.

When in the foregoing description it is stated that the apparatus/processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

For the purpose of the present invention as described herein above, it should be noted that
method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the aspects/embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide

Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

It is noted that the aspects/embodiments and general and specific examples described above are provided for illustrative purposes only and are in no way intended that the present invention is restricted thereto. Rather, it is the intention that all variations and modifications which fall within the scope of the appended claims are covered.

### ABBREVIATIONS

AE Analytics Entity

OEM Customer Experience Management

CM Configuration Management

DSS Decision Support System

OD Operational Diagnosis

EHD Event History Database

KPI Key Performance Indicator

MLB Mobile Load Balancing

MO DN Managed Object's Distinguished Name

MRO Mobility Robustness Optimization

NW Network

OEI Operational Experience Instance

OSS Operations Support System

PM Performance Management

PMD Policy Management Database

QoE Quality of customer Experience

RNP Radio Network Planning

SFI_ID SON Function Instance Identification

SOI SON Operation Instance

SON Self Organizing Networks

TS Traffic Steering

1. A method for use in a logically central entity, comprising:
collecting operational experience information on executed operations from various logical entities via an interface,
the collected operational experience information including execution data and performance data concerning the executed operation, and
storing the collected operational experience information of the executed operations, and
arranging the operational experience information of executed operations into different groups in the central entity according to similarities in the analyzed execution data of the operational experience information.

2. The method according to claim 1, wherein
the operational experience information has been pre-processed by the various logical entities and exchanged between them via other relevant interfaces to enable the pre-processing.

3. The method according to claim 1, wherein
the performance data is obtained from a performance management database, the performance data being calculated by a verification function based on parameters obtained via an interface from the performance management database, and transferred back to the performance management database.

4. The method according to claim 1, further comprising:
calculating a diagnosis value of the executed operation based on the performance data of the executed operation and performance data of previous executed operations having similarities in at least some of the execution data, and
storing the calculated diagnosis value in association with the operational experience information.

5. A method for use in a management entity, comprising:
retrieving operational experience information of at least one previously executed operation via an interface from a central entity, and
processing a planned operation under consideration of the retrieved operational experience information.

6. The method according to claim 5, further comprising:
analyzing execution data included in the operational experience information and determining whether the execution data of the previously executed operation have similarities with at least some of the execution data of the planned operation,
if it is determined that the execution data have similarities,
predicting an outcome of the planned operation based on the retrieved operational experience information.

7. The method according to claim 6, further comprising:
determining whether to execute the planned operation based on the predicted outcome of the planned operation.

8. The method according to claim 5, further comprising:
identifying execution data of an operation to be executed,
searching the central entity for stored operational experience information of previous operations based on the identified execution data,
analyzing the retrieved operational experience information of the previous operations,
if the previous operations having similarities in at least some of the execution data resulted in positive operational experiences,
retrieving parameters of the previous operations having similarities in at least some of the execution data from the operational experience information, and
applying the retrieved parameters for the operation to be executed.

9. The method according to claim 8, further comprising:
if the previous operations having similarities in at least some of the execution data resulted in negative operational experiences,
rejecting the execution of the planned operation.

10.-16. (canceled)

17. The apparatus according to claim 38, wherein
the operational experience information has been pre-processed by the various logical entities and exchanged between them via other relevant interfaces to enable the pre-processing.

18. The apparatus according to claim 38, wherein
the performance data is obtained from a performance management database, the performance data being calculated by a verification function based on parameters obtained via an interface from the performance management database, and transferred back to the performance management database.

19. The apparatus according to claim 38, wherein the at least one memory and the instructions are further configured to, with the at least one processor, cause the apparatus at least to perform:
calculating a diagnosis value of the executed operation based on the performance data of the executed operation and performance data of previous executed operations having similarities in at least some of the execution data, and
storing the calculated diagnosis value in association with the operational experience information.

20. An apparatus for use in a management entity, comprising:
at least one processor,
and
at least one memory for storing instructions to be executed by the processor, wherein
the at least one memory and the instructions are configured to, with the at least one processor, cause the apparatus at least to perform:
retrieving operational experience information of at least one previously executed operation via an interface from a central entity, and
processing a planned operation under consideration of the retrieved operational experience information.

21. The apparatus according to claim 20, wherein the at least one memory and the instructions are further configured to, with the at least one processor, cause the apparatus at least to perform:
analyzing execution data included in the operational experience information and determining whether the execution data of the previously executed operation have similarities with at least some of the execution data of the planned operation,
if it is determined that the execution data have similarities,
predicting an outcome of the planned operation based on the retrieved operational experience information.

22. The apparatus according to claim 21, wherein the at least one memory and the instructions are further configured to, with the at least one processor, cause the apparatus at least to perform:
determining whether to execute the planned operation based on the predicted outcome of the planned operation.

23. The apparatus according to claim 20, wherein the at least one memory and the instructions are further configured to, with the at least one processor, cause the apparatus at least to perform:
identifying execution data of an operation to be executed,
searching the central entity for stored operational experience information of previous operations based on the identified execution data,
analyzing the retrieved operational experience information of the previous operations,
if the previous operations having similarities in at least some of the execution data resulted in positive operational experiences,
retrieving parameters of the previous operations having similarities in at least some of the execution data from the operational experience information, and
applying the retrieved parameters for the operation to be executed.

24. The apparatus according to claim 23, wherein the at least one memory and the instructions are further configured to, with the at least one processor, cause the apparatus at least to perform:
if the previous operations having similarities in at least some of the execution data resulted in negative operational experiences,
rejecting the execution of the planned operation.

25.-30. (canceled)

31. A computer program product embodied on a non-transitory computer-readable medium, said computer program product including a program for a processing device, comprising software code portions for performing the method of claim 1 when the program is run on the processing device.

32.-37. (canceled)

38. An apparatus for use in a logically central entity, comprising:
at least one processor, and
at least one memory for storing instructions to be executed by the processor, wherein
the at least one memory and the instructions are configured to, with the at least one processor, cause the apparatus at least to perform:
collecting operational experience information on executed operations from various logical entities via an interface,
the collected operational experience information including execution data and performance data concerning the executed operation, and
storing the collected operational experience information of the executed operations, and
arranging the operational experience information of executed operations into different groups in the central entity according to similarities in the execution data of the operational experience information.
